(19) United States
(12) Patent Application Publication
(10) Pub. No.: US 2015/0257368 A1
(43) Pub. Date: Sep. 17, 2015

(54) ADJUSTABLE MUZZLE

(71) Applicants: Joyce Harman, Flint Hill, VA (US); Bradley C. Schneider, Washington, VA (US)

(72) Inventors: Joyce Harman, Flint Hill, VA (US); Bradley C. Schneider, Washington, VA (US)

(21) Appl. No.: 14/644,287

(22) Filed: Mar. 11, 2015

Related U.S. Application Data
(60) Provisional application No. 61/951,003, filed on Mar. 11, 2014.

(51) Int. Cl. A01K 25/00; B29C 51/00

(52) U.S. Cl. CPC A01K 25/00; B29C 51/008; B29L 2031/768

(57) ABSTRACT

An adjustable muzzle for horses and other animals is described. The adjustable muzzle may comprise a flat sheet of material with a central portion and four side portions adjacent to the central portion, which side portions serve as flaps. The flat sheet of material may be moldable upon application of heat or other energy so that the flaps may be bent at an angle relative to the central portion to fit the individual shape of the animal's nose, mouth and/or jaw area, such as the snout of a dog or the muzzle of a horse. The muzzle device may be used to slow grazing or prevent chewing or biting of other animals, humans, and objects.

### CROSS-REFERENCE TO RELATED APPLICATIONS

This application claims priority to and the benefit of the filing date of U.S. Provisional Application No. 61/951,003, filed Mar. 11, 2014, the disclosure of which is hereby incorporated by reference herein in its entirety.

### BACKGROUND OF THE INVENTION

1. Field of the Invention

The present invention relates to muzzles for use with horses and other animals. More particularly, the present invention relates to muzzles which shape can be adjusted to fit the shape of an individual animal's snout, nose, mouth and/or jaw area.

2. Description of Related Art

In the equine industry, overeating and obesity lead to a serious and life threatening vascular problem in horse's feet called laminitis. Horses naturally eat grass and live in pastures where they graze freely and exercise. When they get too much to eat, they will not regulate feeding on their own. Muzzles have been created to slow the eating down, but they tend to be bulky affairs with little adjustment for the many shapes of the horses' heads. The worst time of the year for overgrazing is the summer, and these are very hot for a horse to wear.

Horse owners know they need to use a muzzle, but hate to put the bulky items on their horses, and horses are often resistant to wear them. Some horse grazing muzzles of the prior art are constructed of straps of flexible material such as leather or cloth. The straps are arranged as concentric rings with perpendicular reinforcement straps which form a cylinder which fits over the nose, mouth and/or jaw area of the horse. At the end of the muzzle is typically a circular piece of material with a hole to allow relaxed breathing, eating, drinking, or alternatively a cage to prevent unwanted biting (e.g., of another animal or object). Other horse muzzles of the prior art are a cage of plastic material that fit at the end of a horse's nose, mouth and/or jaw area. However, a problem with both these types of prior art muzzles is that they typically only come in a limited number of fixed sizes which may not necessarily conform to the particular geometry of an individual animal's snout, nose, mouth and/or jaw area, which can vary greatly with respect to the relative dimensions of the nose, chin, and mouth. A poor fitting muzzle may cause the horse irritation or sores in the skin of the nose, mouth and/or jaw area and/or make the horse feel constricted, and this may result in resistance in attempts to put the muzzle on. Thus, there is a need in the art for improved horse grazing muzzles and similar muzzles that overcome these limitations.

### SUMMARY OF THE INVENTION

It is an object of the present disclosure to provide an animal muzzle comprising a material that is moldable when energy is applied to the material and rigid when the energy is removed from the material such that the material is configured to be manipulated upon application of the energy to custom fit according to the individual shape of the animal's nose, mouth and/or jaw area, then remain in the custom fit shape when the heat or energy source is removed.

It is another object of the present disclosure to provide an animal muzzle comprising a material that is moldable at higher-than-ambient temperature and rigid at ambient temperature such that the material is configured to be manipulated upon heating the material to custom fit according to the individual shape of the animal's nose, mouth and/or jaw area.

It is still another object of the present disclosure to provide an animal muzzle comprising a sheet of material with flaps such that the sheet of material is flat in the absence of energy applied to the material but upon application of energy applied to the material the flaps may be bent to accommodate the individual shape of the animal's nose, mouth and/or jaw area.

It is yet another object of the present disclosure to provide an animal muzzle comprising a sheet of material with flaps that is moldable at higher-than-ambient temperature and rigid at ambient temperature such that upon heating, the flaps may be bent to accommodate the individual shape of an animal's nose, mouth and/or jaw area.

It is still yet another object of the present disclosure to provide an animal muzzle comprising a flat sheet of material comprising a central portion and one or more side portion, preferably four side portions, such that the side portions may be bent relative to the central portion upon application of energy to the material to provide a fit according to the individual shape of an animal's nose, mouth and/or jaw area and remain bent when the energy is removed from the material.

It is yet still another object of the present disclosure to provide an animal muzzle comprising a flat sheet of material comprising a central portion and four side portions, such that the side portions may be bent relative to the central portion upon application of heat to the material to provide a fit according to the individual shape of the animal's nose, mouth and/or jaw area and remain bent when the heat is removed from the material.

It is another object of the present disclosure to provide a horse muzzle comprising a single flat piece of material with a substantially rectilinear central portion and four curvilinear side portions which serve as flaps, each side portion being adjacent to a side of the central portion. The material may increase its moldability upon application of energy to the material such that one or more of the side portions may be bent at an angle relative to the central portion to provide for a fit that accommodates the individual shape of a horse's nose, mouth and/or jaw area.

It is still another object of the present disclosure to provide a horse muzzle comprising a single flat piece of material with a substantially rectilinear central portion and four curvilinear side portions which serve as flaps, each side portion being adjacent to a side of the central portion. The material may increase its moldability upon application of heat to the material such that the side portions may be bent at an angle relative to the central portion to provide for a fit that accommodates the individual shape of a horse's nose, mouth and/or jaw area.

It is yet another object of the present disclosure to provide a muzzle for an animal comprising a polymeric material wherein the crystalline and/or chemical structure of the polymer may be disrupted upon application of sufficient energy (e.g., heat) to the material such that the material transitions from a rigid state to a moldable state. The material is configured to fit the animal to accommodate the individual shape of the animal's nose, mouth and/or jaw area, such as a snout or muzzle, in its moldable state.

It is still yet another object of the present disclosure to provide a muzzle for an animal comprising a polymeric material wherein the crystalline and/or chemical structure of the polymer may be disrupted upon application of sufficient heat to the material such that the material transitions from a rigid state to a moldable state. The material is configured to fit the animal to accommodate the individual shape of the animal's nose, mouth and/or jaw area in its moldable state.

It is yet still another object of the present disclosure to provide an animal muzzle comprising a single flat piece of material comprising a substantially rectilinear central portion, four curvilinear side portions which serve as flaps, each side portion being adjacent to a side of the rectilinear central portion and a joint at each boundary between the central portion and side portions. The single flat piece of material comprises heat moldable plastic which upon heating the side portions may be bent at an angle relative to the central portion at each joint such that the side portions may be adjusted to accommodate the individual shape of an animal's nose, mouth and/or jaw area. The muzzle may optionally include one or more slots to permit passage of a strap. More particularly, the slots may be disposed in each of the side portions.

It is an object of the present disclosure, that in some embodiments, the muzzle comprises a single sheet of material with a central portion and four side portions adjacent to the central portion. More particularly, the central portion is rectilinear and each side portion has a curvilinear boundary. Even more particularly, the central portion substantially resembles a square, and may further comprise a joint at each boundary between the central portion and side portions. Further still, the muzzle can comprise a single sheet of material with a substantially rectilinear central portion and four side portions, each side portion being adjacent to the central portion and having a curvilinear boundary with the substantially optionally comprising a curved indentation at each corner. The curved indentations at the corners of the substantially rectilinear central portion facilitate projection of the curvilinear side portions.

Further still, the side portions serve as flaps that may be bent at joints between the side portions and central portion when the sheet of material is in a moldable state. The curvilinear side portions may resemble the shape of a partial oval, a semi-circle, a paddle, a leaf, or a projection of a club in a deck of cards.

It is a further object of the present disclosure to provide a muzzle wherein the muzzle or material of the muzzle comprises openings which allow for breathing, eating, or drinking. The openings may be disposed in the central or side portions of the muzzle. In particular aspects, the openings take the configuration of a circle in the center of the central portion and flaps and curvilinear arcs positioned around the central circle to create a circular pattern. It is further an object of the muzzle described to provide punchouts/punchout tabs in the muzzle or material of the muzzle to customize the number and location of openings in the muzzle. In embodiments, the single sheet or flat piece of material comprises perforations outlining one or more removable tabs, which when removed provide one or more voids (otherwise referred to as openings or through holes) in the material. In preferred embodiments, the removable tabs are provided in a half-moon shape.

It is an object of the present disclosure that the material is moldable at a temperature between 100° F. and the melting temperature of the material, such as between 100° F. and 212° F., 110° F. and 212° F., 120° F. and 212° F., 130° F. and 212° F., 140° F. and 212° F., 150° F. and 212° F., 160° F. and 212° F., 170° F. and 212° F., 180° F. and 212° F., 190° F. and 212° F., 200° F. and 212° F. In particular aspects, the material is moldable at about 160° F., or from about 118° F. to 210° F. In other aspects, the material may be moldable at temperatures greater than 212° F. In embodiments where high temperature plastics are utilized to carry out the manufacture of the muzzle described herein, it is understood that appropriate sources of heat will be used to mold the muzzle (e.g., hot water bath, heat guns, stoves, kilns, etc.).

It is an object of the present disclosure that the muzzle can be a muzzle for any animal, and in particular embodiments, a horse muzzle. The muzzle can be any type of muzzle, however, in particular embodiments, the muzzle is a grazing muzzle.

It is another object of the present disclosure to provide a method of fitting a muzzle to an animal (e.g., a horse), comprising providing a single flat piece of heat moldable plastic having a substantially rectilinear central portion, four side portions with curvilinear boundaries which serve as flaps, each side portion being adjacent to a side of the substantially rectilinear central portion, and a joint at each boundary between the central portion and side portions, heating the single flat piece of heat moldable plastic to a temperature at which it becomes heat moldable, and bending the flaps at an angle relative to the central portion such that the muzzle takes on a configuration that accommodates the individual shape of the horse's nose, mouth and/or jaw area.

It is an object of the present disclosure that the material can be heated to a temperature between 100° F. and the melting temperature of the material, such as between 100° F. and 212° F., 110° F. and 212° F., 120° F. and 212° F., 130° F. and 212° F., 140° F. and 212° F., 150° F. and 212° F., 160° F. and 212° F., 170° F. and 212° F., 180° F. and 212° F., 190° F. and 212° F., 200° F. and 212° F. In particular aspects, the material is heated to about 160° F. Further, the material is heated for about 30 seconds to about 1 hour, such as, about 5 minutes to about 30 minutes, about 10 minutes to about 50 minutes, for about 20 minutes to about 40 minutes, for about 5 minutes to 20 minutes, for about 15 minutes to about 45 minutes, for about 5 minutes to about 15 minutes. In particular aspects the material is heated for 45 seconds to 50 seconds. In another embodiment the material is heated for 45 seconds. In still another embodiment, the material is heated for 50 seconds. As one of ordinary skill in the art will recognize, various heating times will differ depending on the plastic used.

Embodiments provide a muzzle for an animal in which the muzzle is adjustable to the animal's nose, mouth and/or jaw shape. Embodiments of the muzzle provide 25-50% or more breathing space in comparison to muzzles of the prior art. In embodiments, the muzzle provides improved comfort for the animal while maintaining effective restriction. As a result, the muzzle of the present disclosure is more likely to be accepted by animals because it offers more breathing space and feels less constrictive. In embodiments, the muzzle is a grazing muzzle for horses.

Further, the present disclosure provides embodiments of a muzzle such as those used for restricting feeding that is easy to keep clean, wash and dry, even disinfect, and does not retain water or dampness that could cause mold. Embodiments include an open, airy design that provides for more comfort in hot weather. Further, the muzzle in embodiments provides access to drinking water while slowing eating, yet allowing horses to get exercise or interact with other horses in the pasture. In addition, embodiments of the muzzle provide additional advantages, including slowing of cribbing, prevention of aggressive biting of other horses, and portability. The muzzle is particularly advantageous in slowing of feeding of hay and other grasses.

### BRIEF DESCRIPTION OF THE DRAWINGS

The accompanying drawings illustrate certain aspects of embodiments of the present invention, and should not be used to limit or define the invention. Together with the written description the drawings serve to explain certain principles of the invention.

FIG. 1 is a photograph of a horse muzzle described herein.

FIG. 2 is a schematic drawing representing a perspective view of an embodiment of a muzzle of the present disclosure with flaps in an unbent state.

FIGS. 3-6 are schematic drawings representing a top plan view of different embodiments of a muzzle of the present disclosure with flaps in an unbent state.

FIG. 7 is a schematic drawing representing a perspective view of an embodiment of a muzzle of the present disclosure where the flaps are in a bent state.

FIG. 8 is a schematic drawing representing a perspective view of an embodiment of a muzzle of the present disclosure where the flaps are in an unbent state.

FIG. 9 is a schematic drawing representing a perspective view of the embodiment shown in FIG. 8 where the flaps are in a bent state.

### DETAILED DESCRIPTION OF VARIOUS EMBODIMENTS OF THE INVENTION

Reference will now be made in detail to various exemplary embodiments of the invention. It is to be understood that the following discussion of exemplary embodiments is not intended as a limitation on the invention. Rather, the following discussion is provided to give the reader a more detailed understanding of certain aspects and features of the invention.

As used herein, the terms “approximately”, “about”, or “around” applied to a value refer to a value that ranges from minus 10% of the value to plus 10% of the value. Thus, “approximately”, “about”, or “around” 100 would refer to any number within the range of from 90 to 110, including the endpoints of the range.

As used herein, the term “snout” is used to refer to the nose, mouth and/or jaw area of the animal. With respect to horses in particular this area is otherwise known in the art as the muzzle, and includes the horse's chin, mouth, and nostrils for example. When referring to a horse or other animals in this disclosure, the terms “snout” and “muzzle” may be used interchangeably.

Muzzle Configuration and Properties

The muzzle described herein is intended for use with any animal. The muzzle described throughout is not limited for use in horses, but in other embodiments can be used for any animal with a snout, including without limitation other equine species, as well as canine, bovine, ovine, and porcine species. This may include farm animals including, without limitation, donkeys, sheep, goats, cows, and pigs, companion animals such as dogs, and zoo animals or exotic animals including without limitation zebras, giraffes, and camels. Embodiments of the muzzle can be used to restrict grazing or feeding, prevent biting of other animals, humans, or objects, or similar uses. It is within the capabilities of a skilled artisan to modify the muzzle of this disclosure for a particular animal or application.

As described herein, the muzzle may be made of any material so long as the moldability or malleability of the muzzle increases when energy is applied to the material and then returns to a rigid state when that energy is removed. Materials retaining these properties permit customization of the muzzle described herein to the dimensions of the animal donning it. The energy applied to the muzzle can be any form of energy, such as heat energy, any form of radiation, mechanical energy, electrical energy, and the like. In particular embodiments, heat energy is used to enhance the moldability or malleability of the muzzle material. The heat energy can be provided through the use of a heated bath (e.g., heated water), a heat gun, stove, kiln, and the like. In more particular aspects, however, the heat energy is provided through the use of a heated bath. In still a more particular aspect, a combination of heat sources (e.g., a heated bath and a heat gun) can be used and spot heating and shaping or re-shaping particular parts of the muzzle to obtain a particular shape and/or fit can be employed.

In one embodiment, the piece of material is a heat moldable material such as a heat moldable plastic polymer, however, any heat-moldable materials may be used. As used herein, the term “heat moldable” refers to moldability or malleability at any temperature in the range of 100° F. up until the actual melting point of the material. However, embodiments of the heat moldable material may be moldable at a temperature in the range of 100° F. to 212° F., 110° F. to 212° F., 120° F. to 212° F., 130° F. to 212° F., 140° F. to 212° F., 150° F. to 212° F., 160° F. to 212° F., 170° F. to 212° F., 180° F. to 212° F., 190° F. to 212° F., 200° F. to 212° F. In one embodiment, the material is moldable at or near the boiling point of water. In a more particular embodiment, the heat moldable material is moldable at about 160° F. In another aspect, the heat moldable material is a high temperature material moldable at temperatures greater than 212° F., such as between 213° F. and 450° F.

In a particular embodiment, the heat moldable material is a heat moldable plastic. Suitable heat-moldable plastics may include (1) heat-moldable thermoplastics (i.e., plastics which require cooling of the mold for solidification), (2) heat-moldable thermosetting plastics (i.e., plastics which become infusible or harden by heating during the molding operations), and combinations thereof.

Non-limiting examples of heat moldable plastic classes include polyolefins, polyamides, polyesters, poly (meth)acrylates, polycarbonates, poly(vinyl halides), polyvinyl alcohols, polynitriles, polyacetals, polyimides, polyarylketones, polyetherketones, polyhydroxyalkanoates, polycaprolactones, polystyrenes, polyurethanes, polysulfones, polyphenylene oxides, polyphenylene sulfides, polyacetates, liquid crystal polymers, fluoropolymers, ionomeric polymers, and copolymers of any of them and combinations of any two or more of them.

Non-limiting examples of specific commercially available heat-moldable plastics include acrylonitrile butadiene styrene (ABS), polymethyl methacrylate (PMMA), cellulose acetate, cyclic olefin copolymer (COC), ethylene-vinyl acetate (EVA), ethylene vinyl alcohol (EVOH), polytetrafluoroethane (PTFE), ionomers, polyoxymethylene (POM or Acetal), polyacrylonitrile (PAN), polyamide 6, polyamide 6,6, polyamide-imide (PAI), polyaryletherketone (PAEK), polybutadiene (PBD), polybutylene (PB), polybutylene terephthalate (PBT), polycaprolactone (PCL), polychlorotrifluoroethylene (PCTFE), polyethylene terephthalate (PET), polycyclohexylene dimethylene terephthalate (PCT), polycarbonate (PC), polyhydroxybutyrate (PHB), polyethylene (PE), polyetheretherketone (PEEK), polyetherketoneketone (PEKK), polyetherimide (PEI), polyethersulfone (PES), chlorinated polyethylene (CPE), polyimide (PI), polylactic acid (PLA), polymethylpentene (PMP), polyphenylene oxide (PPO), polyphenylene sulfide (PPS), polyphthalamide (PPA), polypropylene (PP), polysulfone (PSU), polytrimethylene terephthalate (PTT), polyurethane (PU), polyvinyl acetate (PVA), polyvinyl chloride (PVC), polyvinylidene chloride (PVDC), and styrene-acrylonitrile (SAN), as well as combinations or composite materials thereof. These specific thermoplastics can be substituted or unsubstituted and mixed in any combination suitable to any person having ordinary skill in the art. In particular embodiments, the muzzle described herein is a composite of at least two or more plastics described herein. In more particular embodiments, the muzzle is a composite plastic comprising a synthetic aromatic polyamide polymer (e.g., Kevlar®, commercially available from DuPont).

As described herein, the muzzle comprises a central portion and at least two side portions extending from the periphery of the central portion. In a more particular embodiment, the muzzle is composed of a single flat piece of material. In particular aspects, the single piece of material may include a linear joint at the boundary of each side portion with the central portion which facilitates bending of the side portions (e.g., flaps) when energy is applied to the flat piece of material.

As described herein, the central portion may be any shape so long as the shape is suitable for meeting the purposes and objectives of the disclosed muzzle. Non-limiting examples of shapes suitable for the central portion of the muzzle include, circular, trapezoidal, polygonal, such as a triangular, square, pentagonal, hexagonal, or octagonal. In a particular embodiment, the central portion is a substantially rectilinear central portion having four sides, and roughly resembling a square or rectangle.

Likewise, the at least two side portions (e.g., flaps) can be any size and shape so long as the dimensions of the side portions allow the muzzle to be custom fitted to an animal. The flap configurations may take on a variety of designs for different applications such as to provide configurations tailored to animals with various head and face shapes, sizes, and dimensions (e.g., longer and thinner snouts or muzzles, or shorter and wider snouts or muzzles). The shapes of the flaps can be the same or different. In a particular aspect, the shapes of the flaps are all the same. In another particular aspect, the shapes of the flaps are different. In a particular aspect, the muzzle contains four side portions. In still a more particular aspect, the flaps are curvilinear side portions, with each side portion being adjacent to a side of the central portion and thus having one straight portion that borders on the central portion. The curvilinear side flaps may resemble the shape of a partial oval, a semi-circle, a paddle, a leaf, a projection of a club in a deck of cards, and the like. In particular aspects the curvilinear flaps may further take any shape, as long as the side bordering the central portion is straight and the rest of the side portion is curved. Further, the number of side portions (e.g. flaps) on the muzzle may vary as well. In particular embodiments, the muzzle comprises at least two side portions (e.g., two, three, four, and so on). In a more particular embodiment, the muzzle comprises four side portions (flaps).

Regardless of the shape and/or number of flaps present, the flaps of the muzzle should be individually and selectively customizable to the contours of the animal being fitted to wear the muzzle. In some aspects, each flap may be bent at the same angle relative to the central portion of the muzzle. In other aspects one or more of the flaps may be bent at a different angle relative to the central portion of the muzzle. In particular embodiments, each flap may be bent at any angle from about 10° to about 90° (e.g., about 10°, about 15°, about 20°, about 25°, about 30° about 35°, about 40°, about 45°, about 50°, about 55°, about 60°, about 65°, about 70°, about 75°, about 80°, about 85° about 90°) relative to the central portion according to the size and shape of the animal's nose, mouth and/or jaw area, such as the snout or muzzle of the animal.

The muzzle may further comprise slots positioned at the end of each flap configured to allow passage of a strap. The number of slots is not material so long as the muzzle can be secured to the animal. In various embodiments, the muzzle may comprise between 1 and 20 slots (e.g., 1 slot, 2 slots, 3 slots, 4 slots, 5 slots, 6 slots, 7 slots, 8 slots, 9 slots, 10 slots, 11 slots, 12 slots, 13 slots, 14 slots, 15 slots, 16 slots, 17 slots, 18 slots, 19 slots, 20 slots, and so on).

The muzzle may further comprise openings which allows for breathing, eating, or drinking. The openings may take any shape and may be in any suitable configuration, and may be disposed in the central portion or the curvilinear side portions. In an aspect, there can be a single opening or a multitude of openings, as in between 1 to 20 openings (e.g., 1 opening, 2 openings, 3 openings, 4 openings, 5 openings, 6 openings, 7 openings, 8 openings, 9 openings, 10 openings, 11 openings, 12 openings, 13 openings, 14 openings, 15 openings, 16 openings, 17 openings, 18 openings, 19 openings, 20 openings, and so on). Openings can be disposed on the central portion, the side portions (e.g., the flaps), or on both the central portion and the side portions.

The one or more openings may include an abundance of perforations in the muzzle, openings specifically placed at desired locations in the muzzle, or combinations thereof. In a particular aspect, the openings are specifically placed at desired locations on the central portion and side portions of the muzzle. The number of total openings may range from one opening to forty openings. In a more particular embodiment, the number of openings can be customized by providing the central portion with a plurality of punchout tabs. Upon removal of the punchout tab, an opening is created in the muzzle. Customized opening placement can be achieved through the selective removal of punchout tabs in the central portion and/or side portions of the muzzle described herein.

In particular embodiments, the openings may take the configuration of a circle in the center of the central portion and curvilinear arcs positioned around the central circle to create a circular pattern. However, in other embodiments, the openings may take on different curvilinear shapes or rectilinear shapes such as a square or rectangular shape.

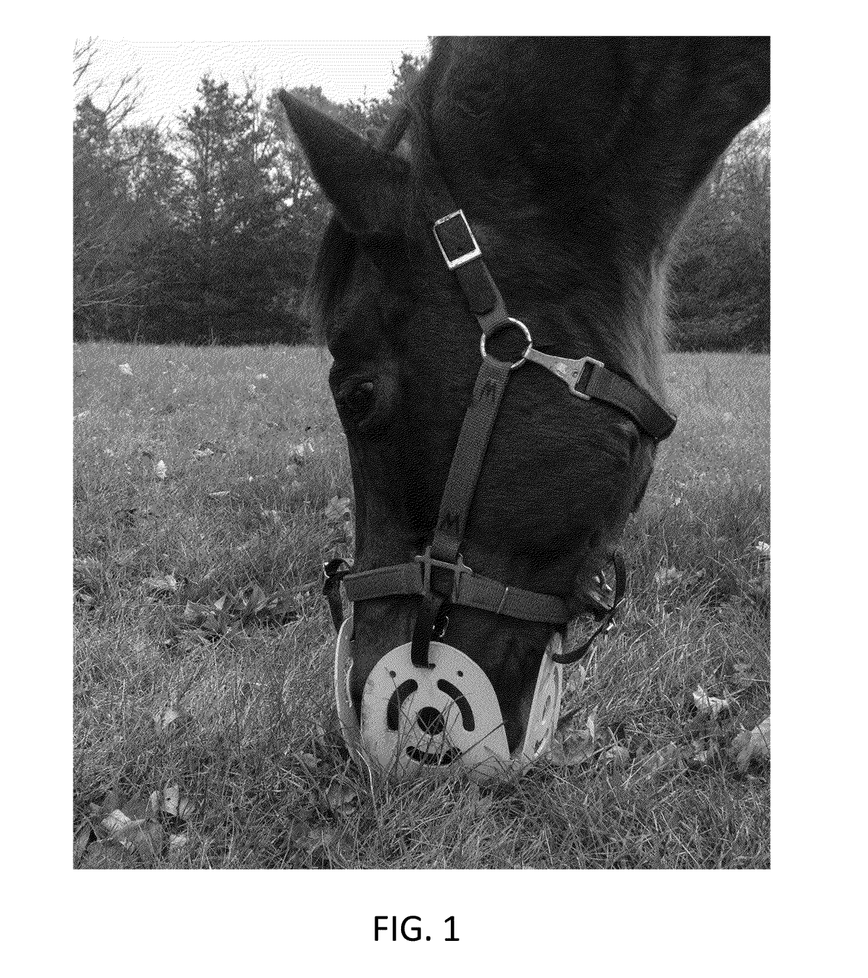

FIG. 1 is a picture of a horse donning an embodiment of the muzzle described herein. As shown in FIG. 1, the muzzle provides a customized fit for the horse. The central portion is not entirely visible; however, in this embodiment the central portion is substantially rectilinear and comprises four curvilinear flaps disposed adjacent to a side of the central portion. Further provided are curved indentations at each corner of the central portion to provide easier individualized fitting when heating and molding the muzzle.

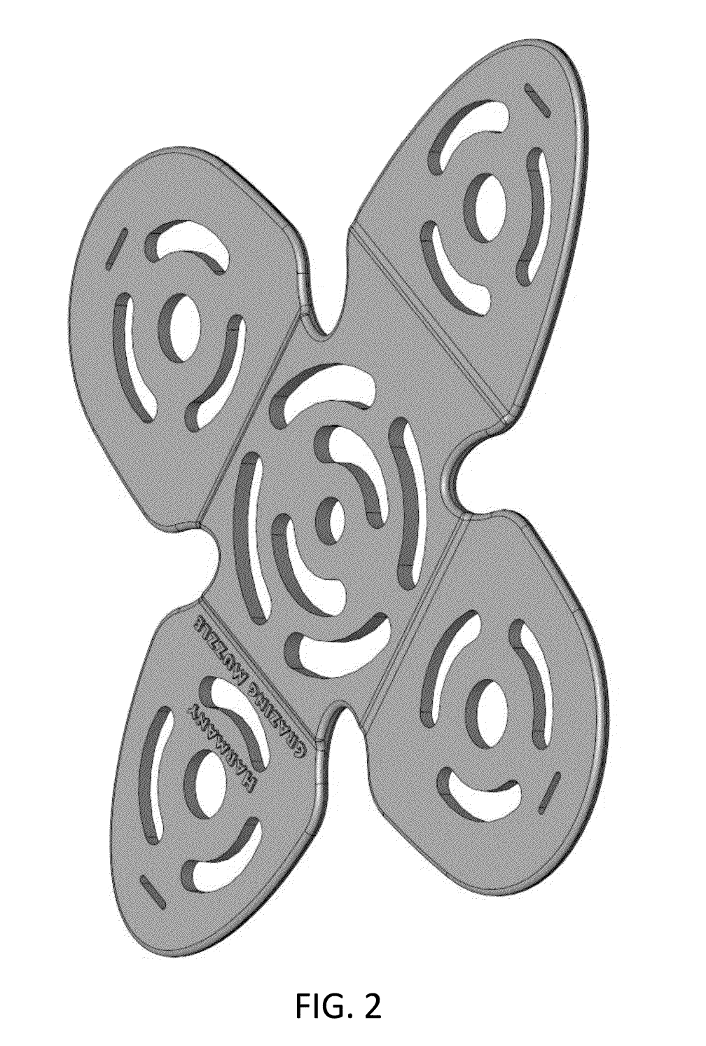

FIG. 2 shows an embodiment of a muzzle of the present disclosure in unfitted form, in which the flaps are coplanar with the central portion. The muzzle comprises a substantially rectilinear central portion with four sides, the central portion roughly resembling a square or rectangle. The substantially rectilinear central portion is surrounded by four curvilinear side portions which serve as flaps, with each side portion being adjacent to a side of the central portion and thus having one straight portion that borders on the central portion. To facilitate projection of the side portions when placed in a fitted configuration, the substantially rectilinear central portion comprises a curved indentation at each corner of the central portion.

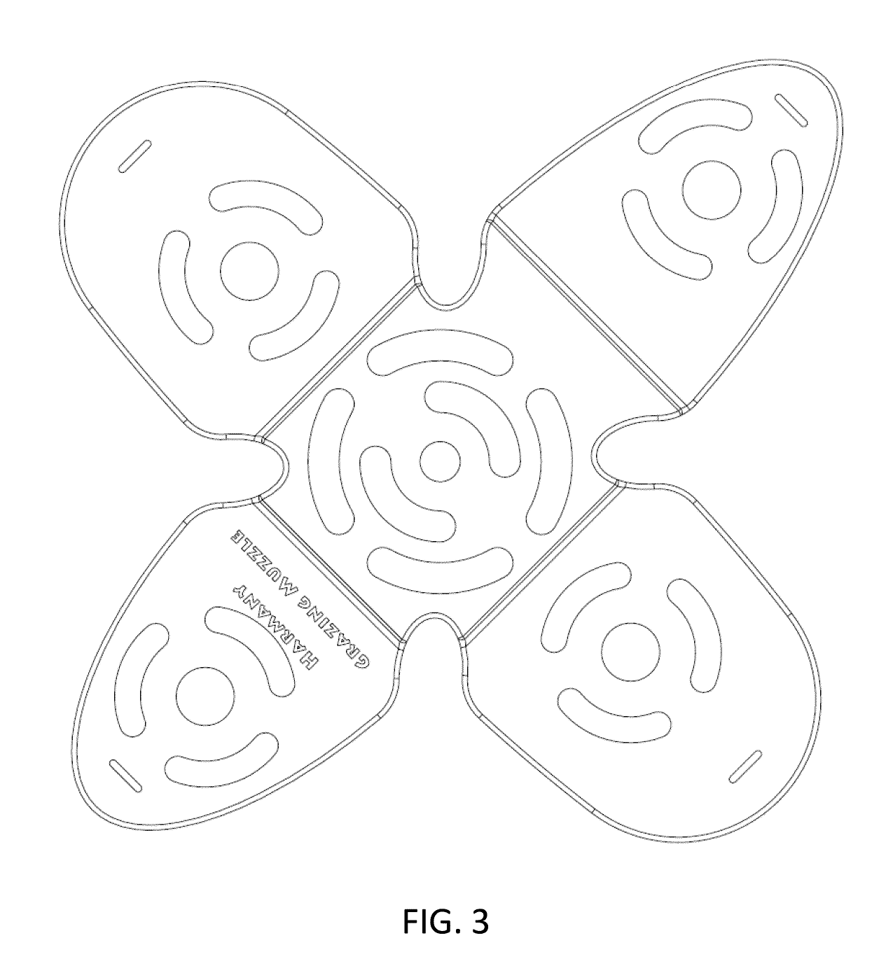

FIGS. 3-6 are schematic drawings representing various embodiments of a muzzle of the present disclosure where the flaps are coplanar with the central portion. As shown in FIGS. 3-6, embodiments of the muzzle may have flaps that may take on different shapes.

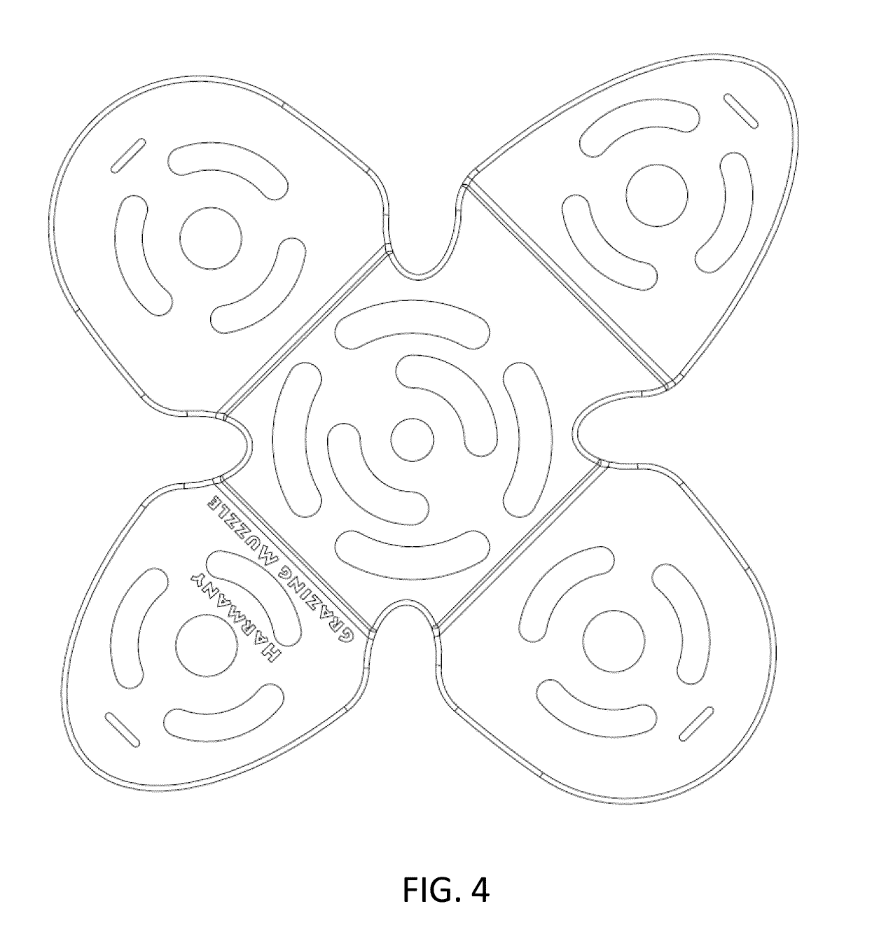

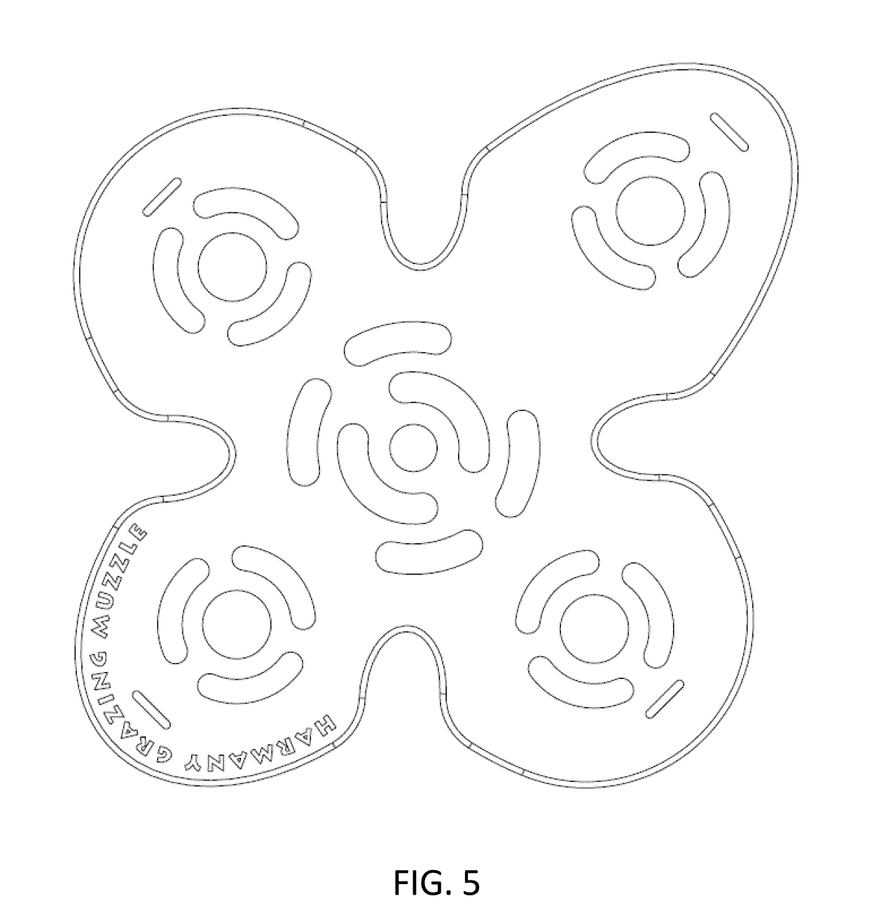

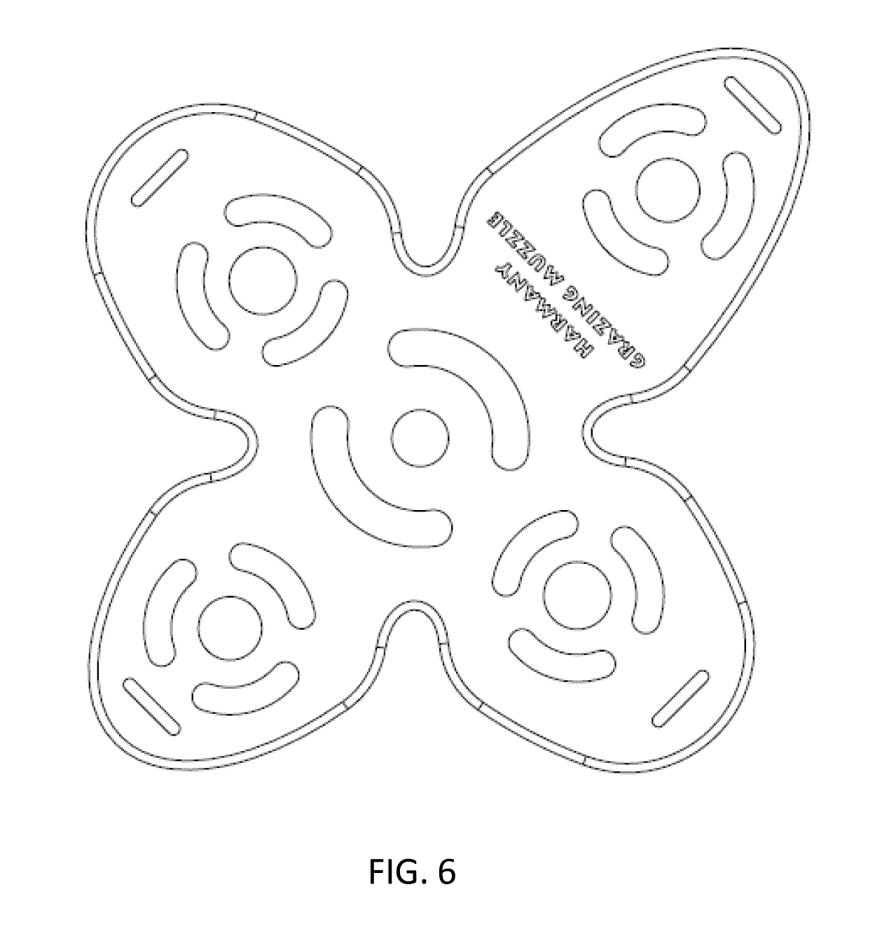

For example, in the embodiments shown in FIGS. 3 and 4, one pair of opposing flaps may take on a rounder shape than the other pair of opposing flaps, which may assume a pointer shape. Further, the length of the flaps may vary in different embodiments, with FIG. 3 assuming a substantially longer shape than FIG. 4. In addition, in some embodiments, three of the flaps may be substantially the same shape with the fourth flap taking on a different shape, such as the long flap shown in FIGS. 5 and 6. In addition, some embodiments such as those shown FIGS. 2-4, a joint or line may border each side portion with the central portion to facilitate bending of the flaps, while in other embodiments such as those shown in FIGS. 5-6, the line or joint may be absent. As shown in FIGS. 3-6, the flap configurations may take on a variety of designs and the particular configurations shown are merely illustrative. Any number of flaps within the muzzle may vary with respect to the shape of the curvilinear border. Further, in other embodiments, less than or more than four flaps may be desired.

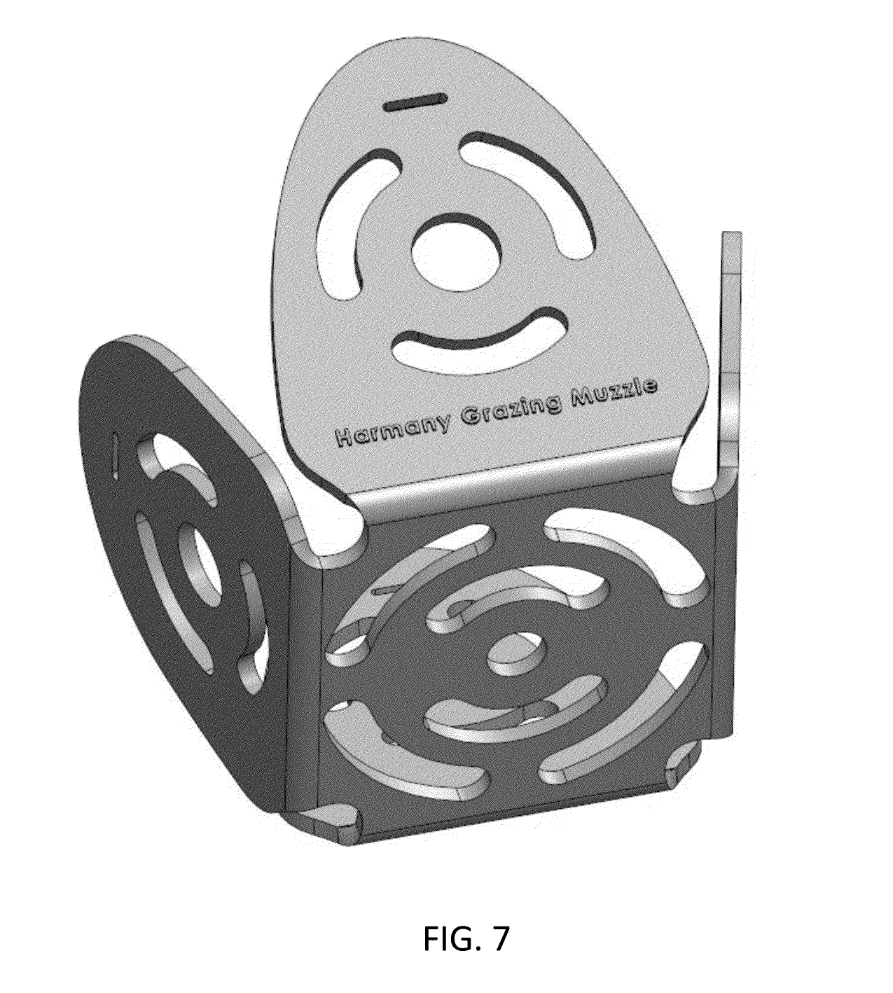

In some embodiments, such as those shown in FIGS. 2-7, the muzzle may be useful for fitting to horses as a grazing muzzle. An embodiment of the muzzle after heat treatment in which the muzzle flaps are folded or bent at an angle relative to the central portion is shown in FIG. 7. However, embodiments include variations where the flaps are bent at alternative angles. The flaps may be bent at any angle from about 10° to about 90°, such as from about from about 30° to about 90°, relative to the central portion according to the size and shape of the animal's nose, mouth and/or jaw area, such as the snout or muzzle of the animal.

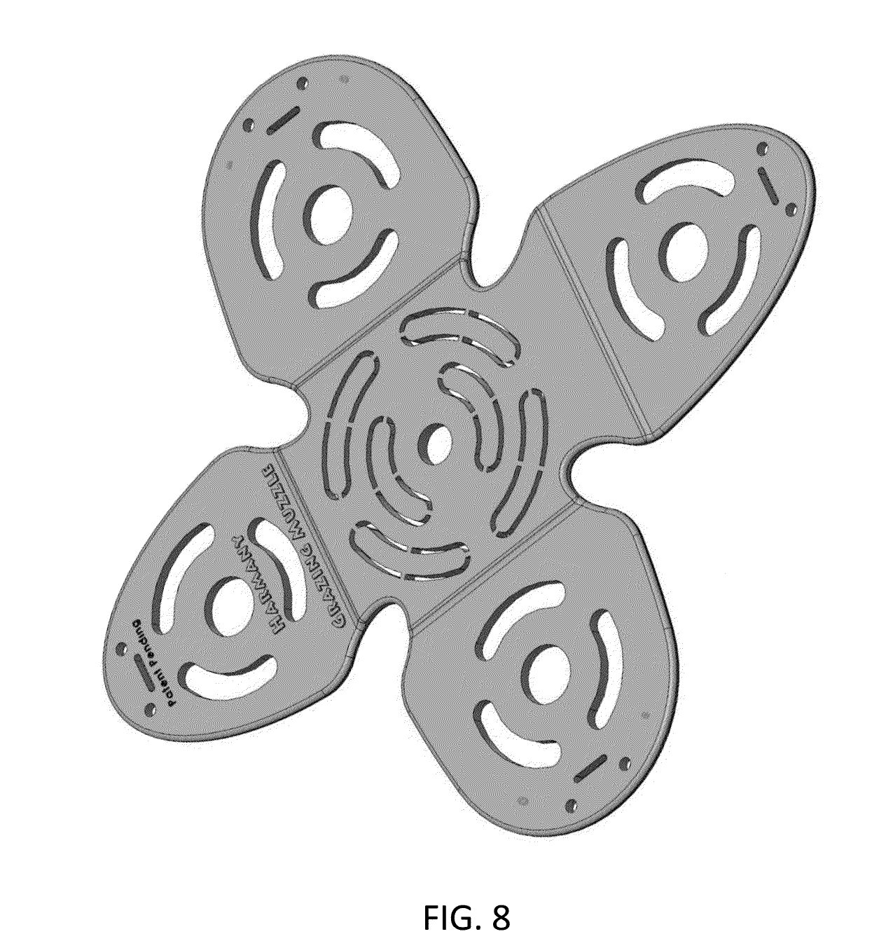

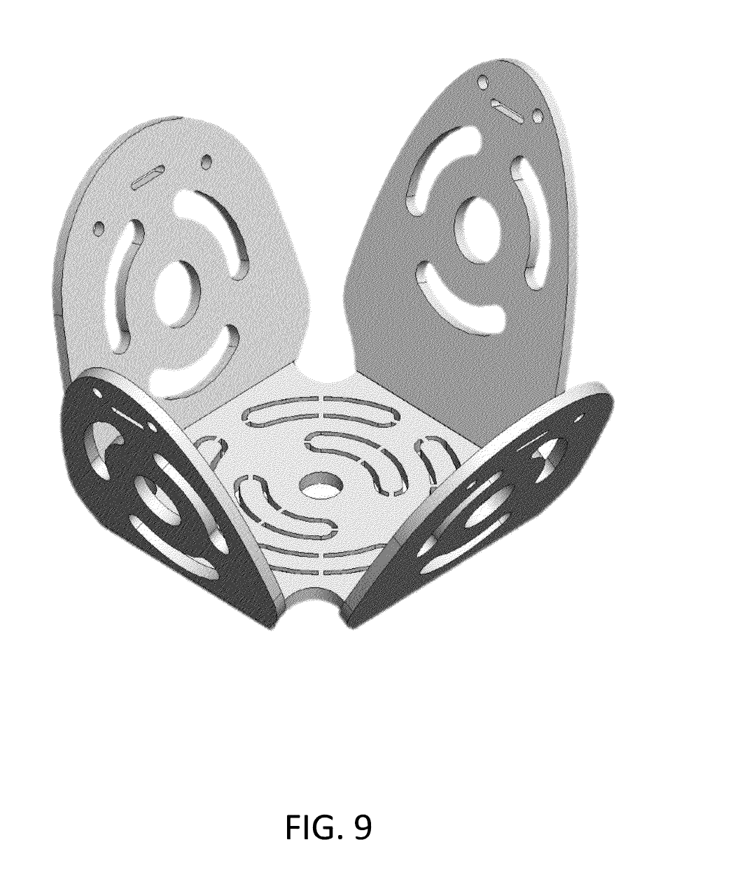

An alternative embodiment of the muzzle before and after heat treatments is shown in FIGS. 8-9. FIGS. 8-9 have punchout tabs to provide customized openings in the muzzle. The shape of the punchout tabs can be any shape so long as the opening following removal of the punchout tab allows for permissible gas exchange between the animal and the environment, as well as eating and drinking if so desired. As with other disclosed embodiments, the flaps may be bent at alternative angles. The flaps may be bent at any angle from about 10° to about 90°, such as from about from about 30° to about 90°, relative to the central portion according to the size and shape of the animal's nose, mouth and/or jaw area, such as the snout or muzzle of the animal.

Instructions for Use/Methods of Use

The following provides a set of instructions/methods for using the muzzle described herein, in particular the embodiment that is a grazing muzzle for horses. The muzzle has 4 flaps with a slot disposed in each flap.

The muzzle is initially flat, so that the fit can be properly customized to fit the animal donning the muzzle (e.g., a horse). First, the straps are placed into the 4 slots. A sufficient quantity of water is heated and the entire sheet of heat moldable plastic is placed into the heated water. The water may be heated to any temperature that would allow the flaps to bend, which may be anywhere from 100° F. to 212° F., depending on the plastic, including anywhere from 110° F. to 212° F., 120° F. to 212° F., 130° F. to 212° F., 140° F. to 212° F., 150° F. to 212° F., 160° F. to 212° F., 170° F. to 212° F., 180° F. to 212° F., 190° F. to 212° F., and 200° F. to 212° F. Preferred are temperatures which allow maximum pliability of the plastic. In a preferred embodiment, the temperature is about 160° F. The plastic may be heated anywhere from about 30 seconds to about an hour or more, including periods in the range of 5 minutes to 30 minutes, 10 minutes to 50 minutes, 20 minutes to 40 minutes, 5 minutes to 20 minutes, 15 minutes to 45 minutes, 5 minutes to 15 minutes, and the like. In a particular aspect, the plastic is heated from about 45 seconds to about 50 seconds at about 160° F. The time required will depend on how long it takes the material to reach the temperature at which it becomes moldable when immersed in water and will depend on how high the temperature of the surrounding water is, with longer immersion times required for lower temperatures and vice versa, and/or depending on the particular type of plastic used. After heating, the flaps may be bent up at an angle according to the shape of the horse's nose, mouth and/or jaw area. The flaps of the muzzle may be individually and selectively customizable to the contours of the animal being fitted to wear the muzzle. In some aspects, each flap may be bent at the same angle relative to the central portion of the muzzle. In other aspects each flap may be bent at a different angle relative to the central portion of the muzzle. In particular embodiments, each flap may be bent at any angle from about 10° to about 90° (e.g., about 10°, about 15°, about 20°, about 25°, about 30° about 35°, about 40°, about 45°, about 50°, about 55°, about 60°, about 65°, about 70°, about 75°, about 80°, about 85° about 90°) relative to the central portion according to the size and shape of the animal's nose, mouth and/or jaw area, such as the snout or muzzle of the animal.

In particular, if the horse has a narrow nose, mouth and/or jaw area, the flaps should be bent close to a right angle. If the horse has a large roman nose, one or more of the flaps should be bent less. If the horse has a big chin at the back, the back flap should be bent less. If the horse has a wide mouth side to side, the side flaps should be bent less. In this way, the muzzle may be custom fit to the size of the horse's nose, mouth and/or jaw area. Generally it is best to leave the central portion fairly flat at the point where the central portion contacts the ground; however, the central portion may be adjusted and bent to fit any shape that seems to work best for the animal donning the muzzle. Animals (e.g., horses) that are known to escape from their muzzles may need a fairly tight fit. After the muzzle is fit, the length of the straps should be adjusted to provide for about a ½ inch clearance between the bottom of the animal's lips and the plastic.

If the animal is a horse and the front strap needs to be secured to keep the muzzle in one place on the noseband, a VETRAP® or similar material may be used to secure the muzzle in place across the front of the halter. When wearing the muzzle, the horse should be fed a treat to observe the chewing action of the animal. There should be a bit of extra room at the back of the muzzle for full jaw action without rubbing as the horse chews. If adjustments are required, the muzzle may be placed back in the heated water and appropriate changes can be made as needed. If, after some use, there are any rubbed places on the horse's nose, mouth and/or jaw area, the hot water adjustment can be repeated. An alternative heat source, such as a heat gun, may also be employed to spot heat particular spots on the muzzle to allow for shaping or re-shaping of the muzzle. If the horse has tender skin or needs extra protection, strips of real sheepskin (it breathes and does not get too hot) can be used. Halter fuzzies or just cut strips of an old sheepskin can be used for this purpose.

The present invention has been described with reference to particular embodiments having various features. In light of the disclosure provided above, it will be apparent to those skilled in the art that various modifications and variations can be made in the practice of the present invention without departing from the scope or spirit of the invention. One skilled in the art will recognize that the disclosed features may be used singularly, in any combination, or omitted based on the requirements and specifications of a given application or design. Other embodiments of the invention will be apparent to those skilled in the art from consideration of the specification and practice of the invention.

It is noted in particular that where a range of values is provided in this specification, each value between the upper and lower limits of that range is also specifically disclosed. The upper and lower limits of these smaller ranges may independently be included or excluded in the range as well. The singular forms “a,” “an,” and “the” include plural referents unless the context clearly dictates otherwise. It is intended that the specification and examples be considered as exemplary in nature and that variations that do not depart from the essence of the invention fall within the scope of the invention. Further, all of the references cited in this disclosure are each individually incorporated by reference herein in their entireties and as such are intended to provide an efficient way of supplementing the enabling disclosure of this invention as well as provide background detailing the level of ordinary skill in the art.

1. An animal muzzle comprising:
a single flat piece of material comprising:
a central portion;
four side portions which serve as flaps, each side portion being adjacent to a side of the central portion;
a joint at each boundary between the central portion and side portions;
wherein the single flat piece of material comprises heat moldable plastic which upon heating the side portions may be bent at an angle relative to the central portion at each joint such that the side portions may be adjusted to accommodate the individual shape of an animal's nose, mouth and/or jaw area.

2. The muzzle of claim 1, wherein the animal is a horse.

3. The muzzle of claim 1, wherein the muzzle is a grazing muzzle.

4. The muzzle of claim 1, wherein the material is moldable at a temperature between 100° F. and 212° F.

5. The muzzle of claim 1, wherein the central portion is substantially rectilinear and each side portion has a curvilinear boundary.

6. The muzzle of claim 1, wherein the central portion substantially resembles a square.

7. The muzzle of claim 1, wherein at least one of the side portions has a shape different from at least one of remaining side portions.

8. The muzzle of claim 1, wherein the substantially rectilinear central portion comprises a curved indentation at each corner.

9. The muzzle of claim 1, wherein the muzzle or material of the muzzle comprises openings which allow for breathing, eating, or drinking.

10. The muzzle of claim 9, wherein the openings are disposed in the central portion or side portions.

11. The muzzle of claim 9, wherein the single flat piece of material comprises perforations outlining one or more removable tabs, which when removed provide one or more voids in the material.

12. The muzzle of claim 1, further comprising at least one slot disposed in each of the side portions to allow passage of a strap.

13. A horse muzzle comprising:
a single flat piece of material comprising:
a substantially rectilinear central portion;
four curvilinear side portions which serve as flaps, each side portion being adjacent to a side of the central portion; and
one or more openings which allow for breathing, eating, or drinking;
wherein an increase in moldability of the material is exhibited upon application of a selected amount of heat to the material such that the side portions may be bent at an angle relative to the central portion to provide for a fit that accommodates the individual shape of a horse's nose, mouth and/or jaw area.

14. The horse muzzle of claim 13, wherein the single flat piece of material comprises perforations outlining one or more removable tabs, which when removed provide one or more voids in the material.

15. A method of fitting a muzzle to a horse, comprising:
providing a single flat piece of heat moldable plastic comprising:
a substantially rectilinear central portion;
four side portions with curvilinear boundaries which serve as flaps, each side portion being adjacent to a side of the substantially rectilinear central portion;
a joint at each boundary between the central portion and side portions;
heating the single flat piece of heat moldable plastic to a temperature at which it becomes heat moldable; and
bending the flaps at an angle relative to the central portion such that the muzzle takes on a configuration that accommodates the individual shape of the horse's nose, mouth and/or jaw area.

16. The method of claim 15, comprising heating the material to a temperature between 100° F. and 212° F.

17. The method of claim 15, comprising heating the material to a temperature of about 160° F.

18. The method of claim 15, comprising heating the material for 30 seconds to about an hour.

19. The method of claim 18, comprising heating the material for about 45 seconds to 50 seconds.

20. The method of claim 15, comprising heating the material with a heat bath, a heat gun, or a combination thereof.
